(19) United States
(12) Patent Application Publication
(10) Pub. No.: US 2002/0083718 A1
(43) Pub. Date: Jul. 4, 2002

(54) Specimen chamber for a cryogenic shipping container

(76) Inventor: Gregg Emmel, Marina Del Rey, CA (US)

Correspondence Address: Roy L. Anderson, Esq., Jeffers, Shaff & Falk, LLP, Suite 1400, 18881 Von Karman Ave., Irvine, CA, 92612, US

(21) Appl. No.: 09/753,208

(22) Filed: Dec. 29, 2000

(51) Int. Cl. F17C 11/00; F25B 19/00

(52) U.S. Cl. 62/46.1; 62/51.1

(57) ABSTRACT

A specimen chamber for storing materials in a dewar vessel that uses liquid cryogen is made of an open-celled porous thermoplastic material that is cryogenically compatible, such as an aerated polypropylene foam. The specimen chamber allows liquid cryogen to pass through it into a plastic foam and allows liquid cryogen in a vapor phase liquid state to pass from the plastic foam into it. The thermoplastic material of the specimen chamber acts as a filter to prevent particles or fragments of plastic foam from entering into the specimen chamber and also acts as a wicking device for rapid transfer of the liquid cryogen to the plastic foam.

### CROSS REFERENCE TO RELATED APPLICATIONS

The present application is related to the following three patent applications, all of which are specifically incorporated herein by reference, and all of which are being filed concurrently with the present application on the same date: Attorney Docket No. JSF35.051, entitled “CRYOGENIC SHIPPING CONTAINER,” Attorney Docket No. JSF35.052, entitled “SELF-VENTING CAP FOR A NECK OF A DEWAR VESSEL,” and Attorney Docket No. JSF35.054, entitled “CONTAINMENT SYSTEM FOR SAMPLES OF DANGEROUS GOODS STORED AT CRYOGENIC TEMPERATURES.”

### FIELD OF THE INVENTION

The present invention is in the field of cryogenic shipping containers.

### BACKGROUND OF THE INVENTION

To ensure reproducible results in research and biotechnical processes, today's scientists and clinical practitioners have found it necessary to genetically stabilize living cells and preserve the integrity of complex molecules for storage and transport. This is accomplished by containing these materials in enclosures where cryogenic temperatures are continuously maintained at or near liquid nitrogen or vapor phase liquid nitrogen temperatures (77 K and 100 K, respectively).

Advances in cryopreservation technology have led to methods that allow low-temperature maintenance of a variety of cell types and molecules. Techniques are available for the cryopreservation of cultures of viruses and bacteria, isolated tissue cells in tissue culture, small multi-cellular organisms, enzymes, human and animal DNA, pharmaceuticals including vaccines, diagnostic chemical substrates, and more complex organisms such as embryos, unfertilized oocytes, and spermatozoa. These biological products must be transported or shipped in a frozen state at cryogenic temperatures to maintain viability. This requires a shipping enclosure that can maintain a cryogenic environment for up to 10 days and meet other shipping requirements such as being relatively impervious to mechanical shock and effects of directional orientation.

In addition to the already existing difficulties posed in shipping heat-sensitive biologicals, the International Air Transport Association (IATA) imposed new regulations which became effective in January 1995 pertaining to all shipments that include specimens containing infectious agents or potentially infectious agents. These regulations, endorsed by the U.S. Department of Transportation (DOT) and applicable to all public and private air, sea, and ground carriers, imposed greatly increased requirements upon shipping units to survive extensive physical damage (drop-testing, impalement tests, pressure containment tests, vibration tests, thermal shock, and water damage) without leakage and without fracture of the internal, primary receptacles (vials). Implementation of this regulation further complicated the shipping of frozen biologicals.

Even though bioshippers are currently available using liquid nitrogen as a refrigerant, little innovation has taken place in the design of packaging for low-temperature transport. Current shippers are generally vulnerable to the physical damage and changes in orientation encountered during routine shipping procedures. Additionally, these shippers rarely comply with the IATA Dangerous Goods Regulation (effective January 1995 or as later amended). Commercial vendors have not developed or certified a cost-effective, standardized shipping unit with the necessary specimen capacity and hold time to meet user demands.

One of the main criticisms of current shippers is price, which varies from $500.00 to $1,000.00 or more per unit. This substantially limits their use for the transport of many biologicals. Because of the initial cost and limited production of these containers, they are designed to be reusable. However, the cost of return shipping of these heavy containers is significant, particularly in international markets.

Users also complain about the absorbent filler used in the current dry shippers, which breaks down with continuous use, contaminating the interior of the container. In fact, one large user of these containers has essentially centered their entire shipping operation around cleaning the broken down absorbent material from the inside of these containers after each use.

Another problem cited by users of currently available dry shippers relates to the functional hold time versus static hold time. Static hold time pertains to a fully charged shipper with no heat load, sitting upright, e.g., essentially not in use. Functional hold time refers to the fully charged shipper in use and containing samples, e.g., in the process of being handled and transported. Even though the static hold time is promoted as being 20 days, if the container is tilted or positioned on its side, the hold time diminishes to hours as opposed to days. This occurs because the liquid nitrogen transitions to the gaseous (vapor) phase more rapidly resulting in outgassing. The liquid nitrogen can also simply leak out of the container when it is positioned on its side.

The current cryogenic containers are promoted as being durable because they are of metal construction. However, rugged handling frequently results in the puncturing of the outer shell or cracking at the neck, resulting in loss of the high vacuum insulation. This renders them useless. The metal construction also adds to the weight of the container, thereby adding substantially to shipping costs.

Thus, there is a need for an improved cryogenic container that can be used to ship biologicals safely, reliably, and economically.

U.S. Pat. No. 6,119,465 seeks to meet this need by using unique, lightweight, low-cost, durable composites and polymers in a semi-disposable vapor phase liquid nitrogen bioshipper. This is accomplished in an inherently simple, reliable, and inexpensive device that will result in reduced shipping costs, enhanced reliability and safety, and fewer service requirements.

The present invention builds upon the framework laid by U.S. Pat. No. 6,119,465, the disclosure of which is specifically incorporated herein by reference. This is done by use of an improved specimen chamber for use in a cryogenic shipping container.

### SUMMARY OF THE INVENTION

The present invention is generally directed to a specimen chamber for storing materials in a dewar vessel that uses liquid cryogen that is made of an open-celled porous thermoplastic material that is cryogenically compatible. The specimen chamber has a base, a side wall attached to the base and a top opening for allowing access into the specimen chamber through a dewar opening in the dewar vessel.

In other, separate aspects of the present invention, the specimen chamber, which is preferably cylindrical, allows liquid cryogen to pass through it into a plastic foam and allows liquid cryogen in a vapor phase liquid state to pass from the plastic foam into it. The thermoplastic material of the specimen chamber acts as a filter to prevent particles or fragments of plastic foam from entering into the specimen chamber. The thermoplastic material also acts as a wicking device for rapid transfer of the liquid cryogen to the plastic foam. The thermoplastic material may be an aerated polypropylene foam.

In yet other, separate aspects of the present invention, the specimen chamber is incorporated into a dewar vessel assembly in which the specimen chamber acts as a wicking device for rapid transfer of liquid cryogen to plastic foam. The specimen chamber is sealed to a neck portion of the dewar vessel so that liquid cryogen must pass through the specimen chamber to reach the plastic foam from the dewar opening and the liquid cryogen in the vapor phase liquid state must pass through the specimen chamber to reach the dewar opening from the plastic foam. A funnel-shaped vessel plate made of a cryogenically compatible material can be sealed to an upper portion of the neck portion.

Accordingly, it is a primary object of the present invention to provide an improved specimen chamber for use in a dewar vessel used to store and transport samples at cryogenic temperatures.

This and further objects and advantages will be apparent to those skilled in the art in connection with the drawings and the detailed description of the preferred embodiment set forth below.

### BRIEF DESCRIPTION OF THE DRAWINGS

FIG. 1 is an exploded assembly drawing of a preferred embodiment of a portable, insulated shipping container according to the present invention with a containment system for dangerous materials.

FIG. 2 is a planar cross section with a partial cutaway view of a preferred embodiment of a portable, insulated shipping container.

FIG. 3 is an assembly drawing of a preferred embodiment of a dewar vessel assembly.

FIG. 4 is an exploded assembly drawings of a preferred embodiment of a self-venting cap taken from reverse directions.

FIGS. 5A-5C are a planar cross section of a preferred embodiment of a portable, insulated shipping container showing connection of a preferred self-venting cap.

### DETAILED DESCRIPTION OF THE PREFERRED EMBODIMENTS

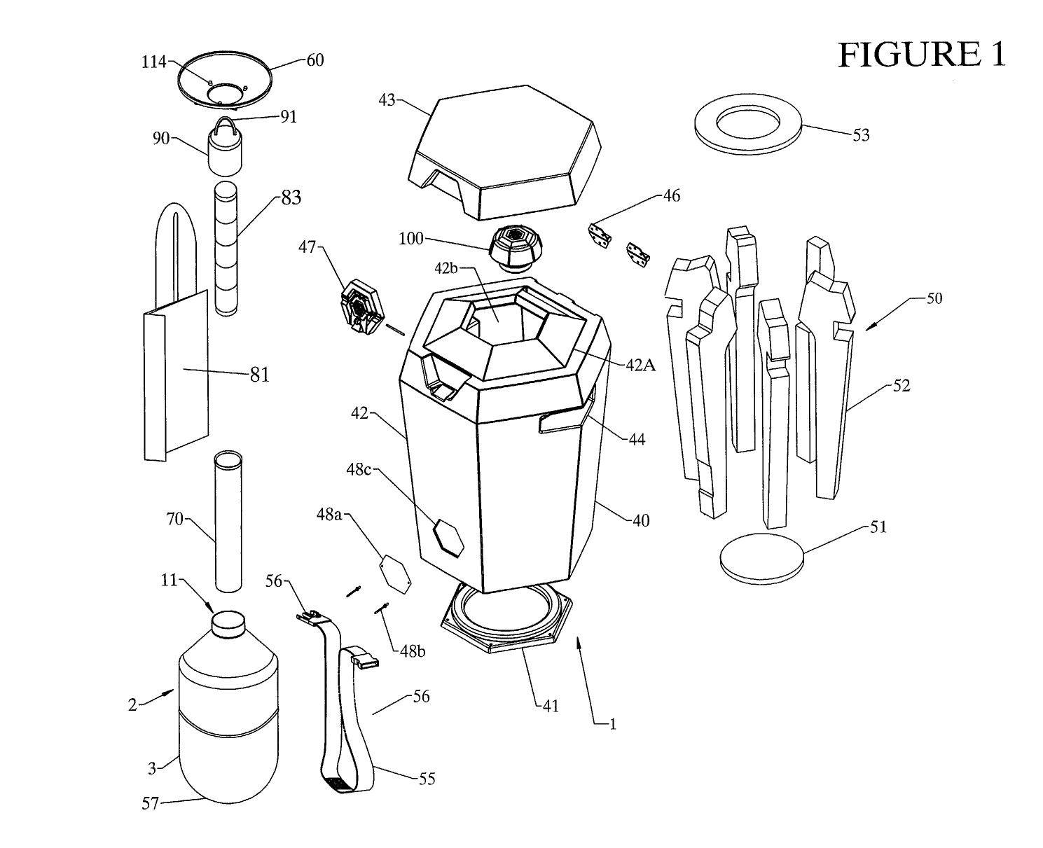

The preferred embodiments of the present invention can be used as part of an overall system that utilizes several inventions. Broadly speaking, there is an overall cryogenic shipping container system. Within the shipping container, there is a dewar vessel. Within the dewar vessel, there is a specimen chamber for holding specimens. Although FIGS. 1-5 are described in greater detail below, the following is a glossary of the elements identified in the Figures:

1 portable, insulated shipping container

2 dewar vessel

3 outer casing of dewar vessel 2

3a upper half of outer casing 3

3b bottom half of outer casing 3

4 opening at top of outer casing 3

5 evacuable space between outer casing 3 and inner casing 13

6 getter pack

7 desiccant

8 nipple

10 layer of super insulation

11 dewar opening into inner vessel 13

13 inner vessel of dewar vessel 2

13a upper half of inner vessel 13

13b lower half of inner vessel 13

14 opening at top of inner vessel 13

15 inner wall of inner vessel 13

21 neck portion of dewar vessel 2

30 plastic foam

31 foam segment of plastic foam 30

32 capillarity separation layer of foam 30

40 outer shipping container shell

41 base of outer shipping container shell 40

42 side wall of outer shipping container shell 40

42a top side wall of side wall 42

42b top opening formed in top side wall 42a

43 top wall of outer shipping container shell 40

44 handle molded in outer shipping container shell 40

45 pocket for paperwork formed in outer shipping container shell 40

46 hinge mechanism

47 latch mechanism

48 certification plate assembly

48a certification plate

48b rivet for certification plate assembly 48

48c indentation in outer shipping container shell 40 for certification plate

50 support assembly for dewar vessel 2

51 bottom portion of support assembly 50

52 side rib portion of support assembly 50

53 top portion of support assembly 50

55 safety strap

56 adjustable buckle of safety strap 55

67 outer bottom of dewar vessel 2

60 funnel-shaped vessel plate

61 support for plate 60

62 spray foam

70 specimen chamber

71 side wall of specimen chamber 70

72 base of specimen chamber 70

73 top opening of specimen chamber 70

80 containment system

81 bag of containment system 80

83 porous structural cartridge of containment system 80

90 inner plug

91 handle of inner plug 90

100 self-venting cap

101 lower component of self-venting cap 100

102 upper component of self-venting cap 100

102a lower surface of upper component 102

103 seal of self-venting cap 100

104 third component of self-venting cap 100

105 plate

106 screw (threads not shown)

107 cover plate

108 female thread in lower component 101

111 male thread

112 female thread

113 positioning device

114 second positioning device

115 rib

121 first plurality of apertures in lower component 101

122 second plurality of apertures in upper component 102

131 first chamber of self-venting cap 100

132 second chamber of self-venting cap 100

133 vent opening of self-venting cap 100

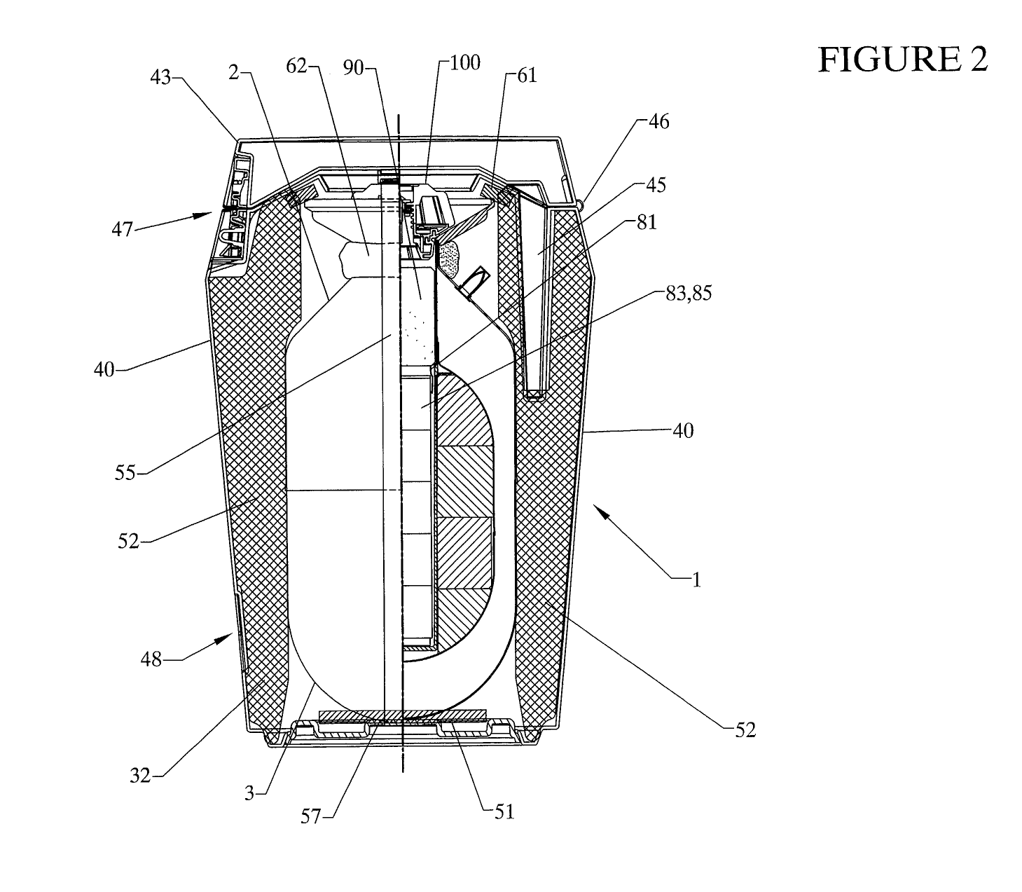

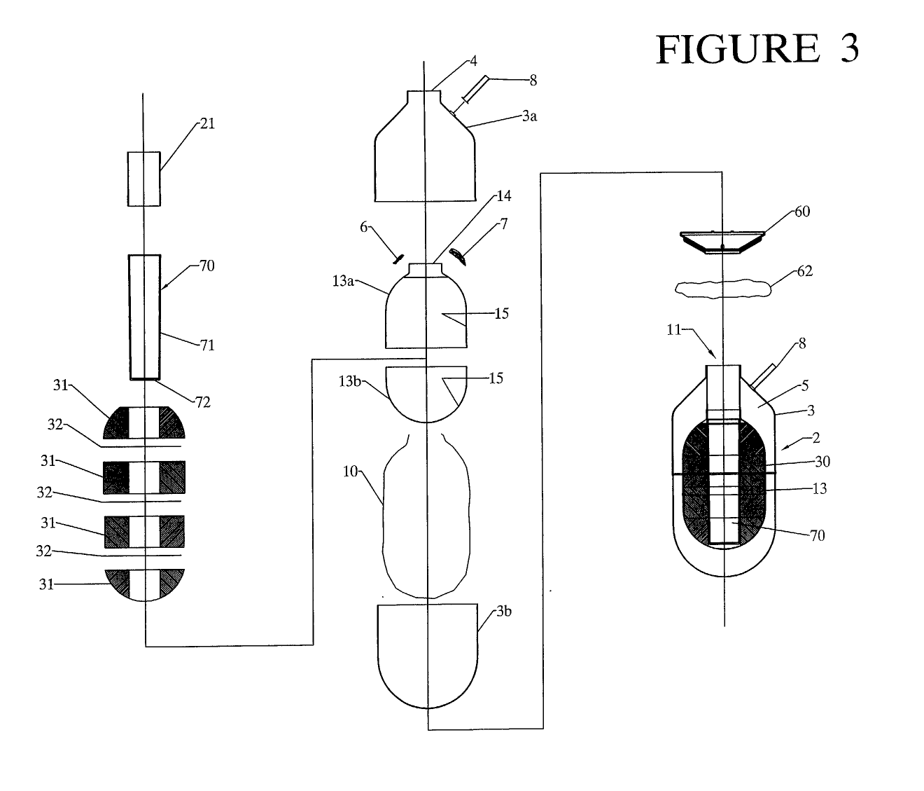

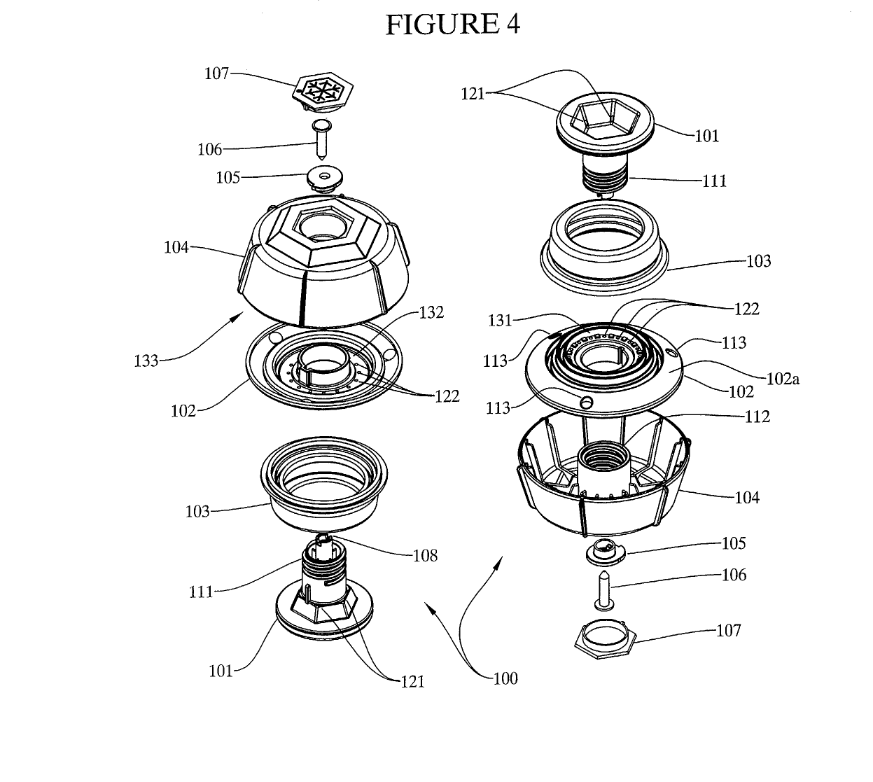

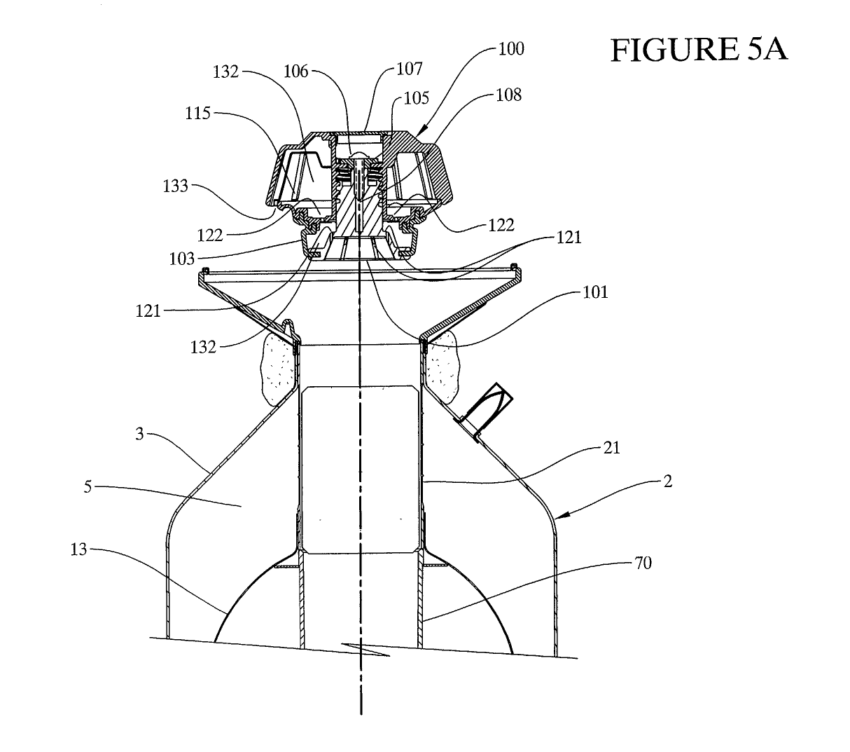

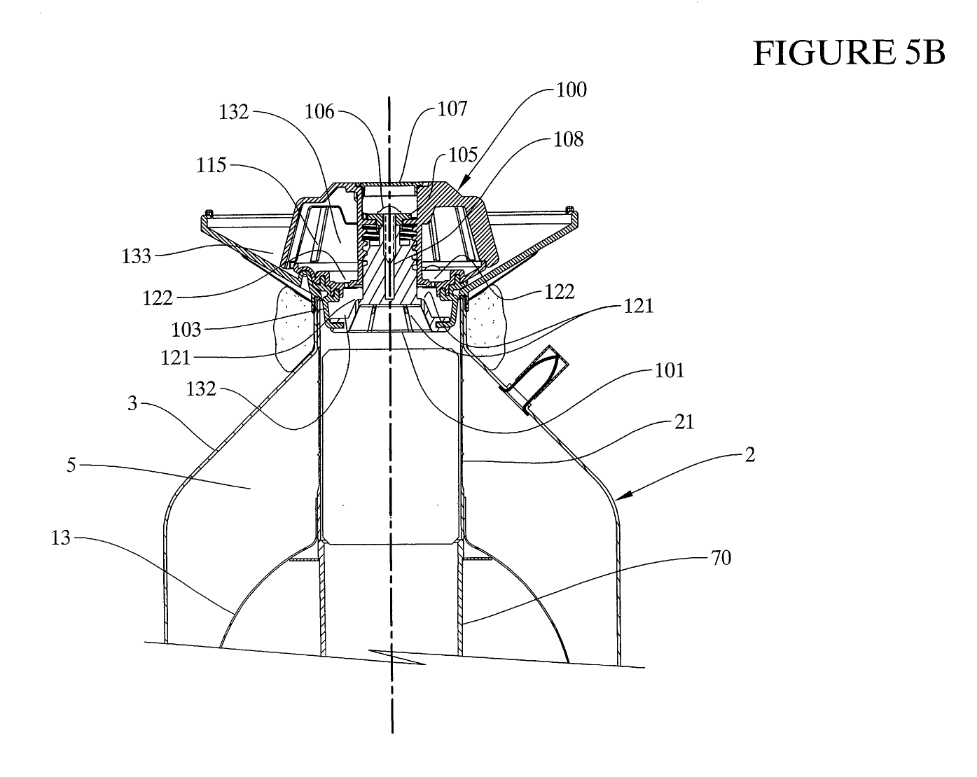

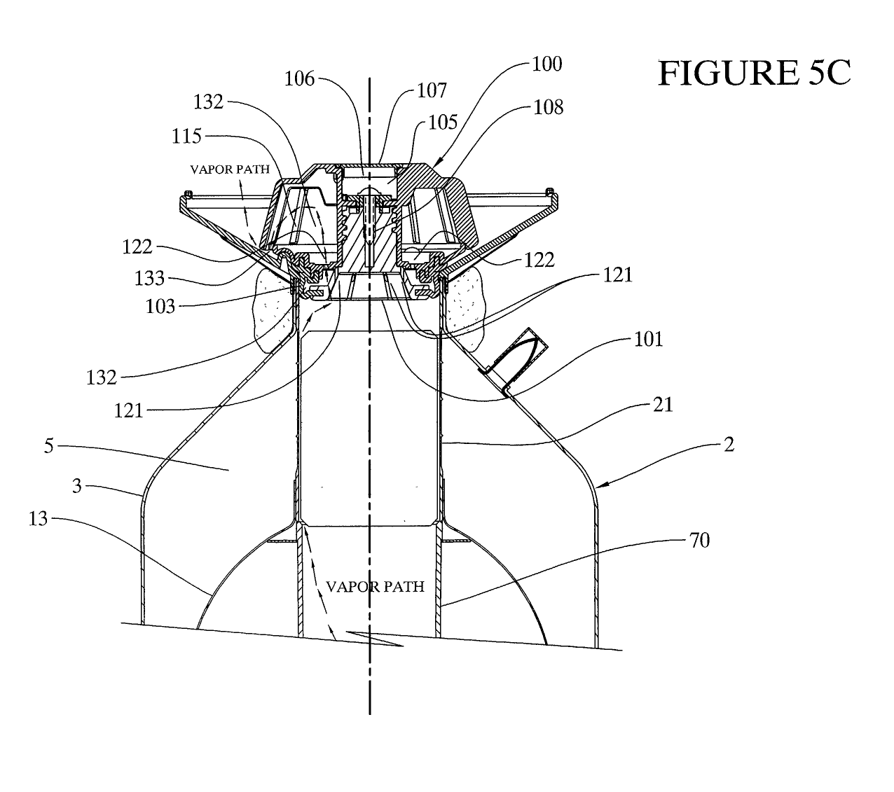

FIG. 1 provides an assembly drawing that illustrates all of the components of the cryogenic shipping container, generally designated as 1, in a disassembled state, and FIG. 2 illustrates how all of these components fit together in an assembled state. FIG. 3 is an assembly drawing that illustrates how dewar vessel 2 is assembled. FIGS. 4 and 5 illustrate an especially preferred self-venting cap useful with a dewar vessel. All of these Figures, as well as the assembly of parts illustrated in these Figures, are described in detail in a patent application filed concurrently herewith, Attorney Docket No. JSF35.051, entitled “CRYOGENIC SHIPPING CONTAINER, the disclosure of which is specifically incorporated herein by reference. However, it is worth repeating, for the sake of clarity herein, that a dewar vessel has an outer casing and an inner vessel with each having openings at their tops connected together by a neck portion forming an evacuable space between the outer casing and the inner vessel and a dewar opening into the inner vessel. As shown in FIG. 1, the dewar vessel, generally designated as 2, has a specimen chamber 70 that is accessed by a dewar opening 11. When shipping container 1 is ready for use after it has been fully charged with a liquid cryogen, a sample receptacle is placed inside of specimen chamber 70 through dewar opening 11.

A preferred embodiment of dewar vessel 2 according to the present invention is constructed as follows. Neck portion 21 is sealed to specimen chamber 70 by epoxy. A plastic foam 30 that holds a liquid cryogen (not shown) is constructed in several segments 31 that are separated by a capillarity separation layer 32. Plastic foam 30 surrounds specimen chamber 70, and then this assembly is placed inside of upper half 13a and lower half 13b which are joined together to form inner vessel 13 with an opening 14 at its top. A getter pack 6 and a desiccant 7 are secured to the top outside of inner vessel 13 by epoxy and metal tape, respectively. (The use of a getter pack and a desiccant are well known within the industry and are not an inventive aspect of the present invention.) Next, a layer of super insulation 10 is used to surround this assembly. For ease of manufacture and economy, it is especially preferred that super insulation 10 be spirally wrapped and that it be constructed of a single component (e.g., a one-sided metalized polymer film). The top of neck portion 21 is then sealed to an opening 4 in upper half 3a by epoxy which is joined together with lower half 3b to form outer casing 3 and an evacuable space 5 between outer casing 3 and inner vessel 13.

Plastic foam 30 is preferably an open-celled plastic foam that is cryogenically compatible. It is especially preferred that plastic foam 30 be a phenolic foam (such material is inexpensive and commonly used as a water-holding base for floral arrangements). Plastic foam 30 can either be foamed in place or it can be pre-manufactured in blocks and then broken down into chunks and inserted into the space surrounding specimen chamber 70. It is especially preferred that plastic foam 30 occupies substantially all of the volume between inner wall 15 of inner vessel 13 and specimen chamber 70.

The open cell structure of plastic foam 30 retains a liquid cryogen, such as liquid nitrogen, by absorption, adsorption, and surface tension as it saturates foam 30. The physical properties of a liquid cryogen (such as liquid nitrogen) and plastic foam 30 are such that the liquid cryogen remains in plastic foam 30 and does not migrate back into specimen chamber 70 when plastic foam 30 is properly charged and comprised of the right thickness of segments 31. Plastic foam 30 can absorb liquid nitrogen up to six times faster than previously used materials. This feature accelerates the process of charging dewar vessel 2 with liquid cryogen. It is especially preferred that plastic foam 30 has a free volume of greater than 95%.

It is especially preferred that specimen chamber 70 be made of an open-celled porous thermoplastic material that is cryogenically compatible, such as an aerated polypropylene foam. Specimen chamber 70 can be formed in a single piece construction with a base 72 connected to a cylindrically-shaped side wall 71 having a top opening 73. The outer circumference of side wall 71 at top opening 73 is sealed to either neck portion 21 or an inner wall of inner vessel 13. Specimen chamber 70 should allow liquid cryogen to pass through it into plastic foam 30 and allow the cryogen in a vapor phase liquid state to pass into it from absorbent foam 30. The thermoplastic material of specimen chamber 70 acts as a filter to prevent particles or fragments of plastic foam 30 from entering into specimen chamber 70, and it also acts as a wicking device for rapid transfer of the liquid cryogen to plastic foam 30. In addition to its superior physical properties, specimen chamber 70 is lightweight and less expensive to manufacture than previous specimen chambers made of metal or a metal alloy.

The combination of specimen chamber 70 and plastic foam 30 in the preferred embodiment of dewar vessel 2 results in greater utilization of the volume of inner vessel 13 with greatly reduced charging time. Unlike many prior dewar vessels, plastic foam 30 occupies substantially all of the volume between inner wall 15 of inner vessel 13 and sample chamber 70, and liquid cryogen can rapidly pass from specimen chamber 70 into plastic foam 30 along the entire side wall 71. The decreased time required to fully charge a dewar vessel with liquid cryogen is attributable to the physical properties of specimen chamber 70 and plastic foam 30. These properties can be demonstrated by pouring approximately _percent of a full charge of liquid cryogen into specimen chamber 70 of shipping container 1 and then turning container 1 upside down. By the time shipping container 1 is turned upside down, all of the liquid cryogen will be held by plastic foam 30 and virtually no liquid cryogen will be released.

Accordingly, it will be apparent to those skilled in the art that still further changes and modifications in the actual concepts described herein can readily be made without departing from the spirit and scope of the disclosed inventions as defined by the following claims.

What is claimed is:

1. A specimen chamber for a portable, insulated shipping container for storing materials at cryogenic temperatures through the use of a liquid cryogen in a dewar vessel, comprising:
a base;
a side wall attached to the base; and
a top opening for allowing access into the specimen chamber through a dewar opening in the dewar vessel;
wherein the base and side wall are comprised of an open-celled porous thermoplastic material that is cryogenically compatible.

2. A specimen chamber as recited in claim 1, wherein the specimen chamber allows the liquid cryogen to pass through the specimen chamber into a plastic foam and allows the liquid cryogen in a vapor phase liquid state to pass from the plastic foam into the specimen chamber.

3. A specimen chamber as recited in claim 2, wherein the thermoplastic material acts as a filter to prevent particles or fragments of the plastic foam from entering into the specimen chamber.

4. A specimen chamber as recited in claim 3, wherein the thermoplastic material acts as a wicking device for rapid transfer of the liquid cryogen to the plastic foam.

5. A specimen chamber as recited in claim 1, wherein the thermoplastic material is an aerated polypropylene foam.

6. A specimen chamber as recited in claim 1, wherein the side wall is cylindrically-shaped.

7. A dewar vessel assembly, comprising:
a dewar vessel having an outer casing and an inner vessel with each having openings at their tops connected together by a neck portion forming an evacuable space between the outer casing and the inner vessel and a dewar opening into the inner vessel;
a specimen chamber held within the inner vessel that extends inside the inner vessel and is accessed through the dewar opening; and
a plastic foam held within the inner vessel between an inner wall of the inner vessel and the specimen chamber;
wherein the specimen chamber acts as a filter to prevent particles or fragments of the plastic foam from entering into the specimen chamber while allowing a liquid cryogen to pass through the specimen chamber into the plastic foam and allowing the liquid cryogen in a vapor phase liquid state to pass from the plastic foam into the specimen chamber.

8. A dewar vessel assembly as recited in claim 7, wherein the plastic foam is cryogenically compatible.

9. A dewar vessel assembly as recited in claim 7, wherein the plastic foam is an open cell plastic foam.

10. A dewar vessel assembly as recited in claim 9, wherein the plastic foam is a phenolic foam.

11. A dewar vessel assembly as recited in claim 7, wherein the specimen chamber acts as a wicking device for rapid transfer of the liquid cryogen to the plastic foam.

12. A dewar vessel assembly as recited in claim 7, wherein the specimen chamber is comprised of an open-celled porous thermoplastic material that is cryogenically compatible.

13. A dewar vessel assembly as recited in claim 7, wherein the thermoplastic material is an aerated polypropylene foam.

14. A dewar vessel assembly as recited in claim 7, wherein the specimen chamber is cylindrically-shaped.

15. A dewar vessel assembly as recited in claim 7, wherein the specimen chamber is sealed to the neck portion so that the liquid cryogen must pass through the specimen chamber to reach the plastic foam from the dewar opening and the liquid cryogen in the vapor phase liquid state must pass through the specimen chamber to reach the dewar opening from the plastic foam.

16. A dewar vessel assembly as recited in claim 7, further comprising:
a funnel-shaped vessel plate made of a cryogenically compatible material that is sealed to an upper portion of the neck portion.
